(19) United States
(12) Patent Application Publication
(10) Pub. No.: US 2006/0019138 A1
(43) Pub. Date: Jan. 26, 2006

(54) Shift membrane burner fuel cell combination

(75) Inventors: Daniel Jansen, Alkmaar (NL); Jan Wilco Dijkstra, Grootekroek (NL); Arend De Groot, Alkmaar (NL)

Correspondence Address: YOUNG & THOMPSON, 745 SOUTH 23RD STREET, 2ND FLOOR, ARLINGTON, VA, 22202, US

(73) Assignee: Stichting Energieonderzoek Centrum Nederland, Petten (NL)

(21) Appl. No.: 10/524,826

(22) PCT Filed: Aug. 29, 2003
(86) PCT No.: PCT/NL03/00605

§ 371 Date: Feb. 18, 2005

(30) Foreign Application Priority Data
Aug. 30, 2002 (NL) 1021364

(51) Int. Cl. H01M 8/06; C01B 31/20

(52) U.S. Cl. 429/26; 423/437.2; 429/34

(57) ABSTRACT

Method and device for converting CO on one side of a membrane with the addition of water to give CO2 and H2O. During this reaction H2 passes through the membrane. On the other side of the membrane H2 is combined with oxygen and burned. This oxygen can be supplied in the form of air and can originate from a fuel cell or fed thereto. CO and H2 originate from a fuel cell.

The present invention relates to a method for converting CO on one side of a membrane in the presence of water to CO₂ and H₂O on said one side of said membrane, H₂ passing through said membrane to the other side of said membrane and said hydrogen being combusted on said other side with oxygen fed to said other side. This reaction is known as a water gas shift reaction.

The aim of the present invention is to apply the water gas shift reaction in other fields and to provide a relatively concentrated stream of carbon dioxide gas. This aim is realised with a method as described above in that the feed to the one side of the membrane comprises anode off-gas from a fuel cell. The effect of the invention can be further improved if the oxygen with which the hydrogen is combusted comprises cathode gas from said fuel cell.

In this context the oxygen or air can either be fed from the shift membrane burner to the fuel cell or can originate from the fuel cell and be fed to the shift membrane burner.

It is pointed out that a method is disclosed in EP 1 033 769 in which anode off-gas is fed via an autothermic reactor to a shift membrane reactor. A fuel such as petrol is also added in the autothermic reactor. Hydrogen passes through the membrane of the membrane reactor, which hydrogen, however, in contrast to the present invention, is not combusted in the membrane shift reactor but is used to feed a following component. That is to say, the product of the permeate side of the membrane shift reactor is hydrogen and in the case of the present invention an aqueous stream.

According to the invention this method is used on the off-gases from a fuel cell and more particularly a solid oxide fuel cell (SOFC). An important characteristic of an SOFC fuel cell is that combustion of the carbon-containing fuel takes place without this resulting in mixing of the fuel with nitrogen from the air required for the combustion. The anode off-gas consisting of, inter alia, CO and H₂ is fed, with the addition of water, to the one chamber and combustion of hydrogen takes place in the other chamber with the cathode off-gas that will consist of air containing a percentage of oxygen that may or may not be somewhat reduced, or another gas containing oxygen.

Of course, any catalysts required will be provided in the relevant chambers adjacent to the membrane, or the membrane itself will be provided with any requisite catalysts. The various requirements are associated with the operating temperature and operating pressure under which the device is operated. Temperatures of 150 to 1400° C. and pressures of up to a few tens of atmospheres are possible.

Such temperatures can be obtained by allowing the relatively hot exhaust gases from the shift membrane burner to enter into heat exchange with the incoming gases from the shift membrane burner or from the fuel cell. Optionally, separate heating of the gases can take place. The relatively high pressures can be obtained by driving a turbine with the energy present in the exhaust gases from the shift membrane burner, which turbine is coupled to a compressor on the other side. A wide variety of variants of such a set-up is possible, depending on the requirements imposed on the system thus obtained. For instance, it is possible to use various shift membrane burners one after the other, all of which may or may not be combined with an SOFC, a common (gas) turbine being employed. Electricity can be generated using such a turbine.

Although the invention has been described above with reference to an SOFC, it will be understood that any other fuel cell can be combined with a shift membrane burner. Such fuel cells will, of course, generate electricity. Before they are stored and/or discharged, the exhaust gases originating from the shift membrane burner can also not only be used for compressing and/or heating the incoming gases but also for generating energy, such as electricity, by means of these or for meeting heating needs.

Using the method described above it is possible when burning fossil fuels to obtain exhaust gases which consist, on the one hand, mainly of water and air and, on the other hand, of a gas in which carbon is mainly present in the form of carbon dioxide. This carbon dioxide can, for example, be injected into underground exhausted natural gas fields.

The invention also relates to a system comprising an SOFC fuel cell and a device for reacting CO and H₂, comprising a hydrogen-permeable membrane delimited on either side by, respectively, a first and a second chamber, wherein said first chamber is provided with feed means for CO and H₂ and with discharge means for CO₂ and H₂O and said second chamber is embodied as a combustion chamber and is provided with oxygen feed means and water discharge means, wherein the anode outlet of said SOFC cell is connected to said first chamber and the cathode outlet to said second chamber.

The invention will be explained in more detail below with reference to illustrative embodiments shown highly diagrammatically in the drawing. In the drawing:

FIG. 1 shows an elementary embodiment of a combination of an SOFC and a shift membrane burner;

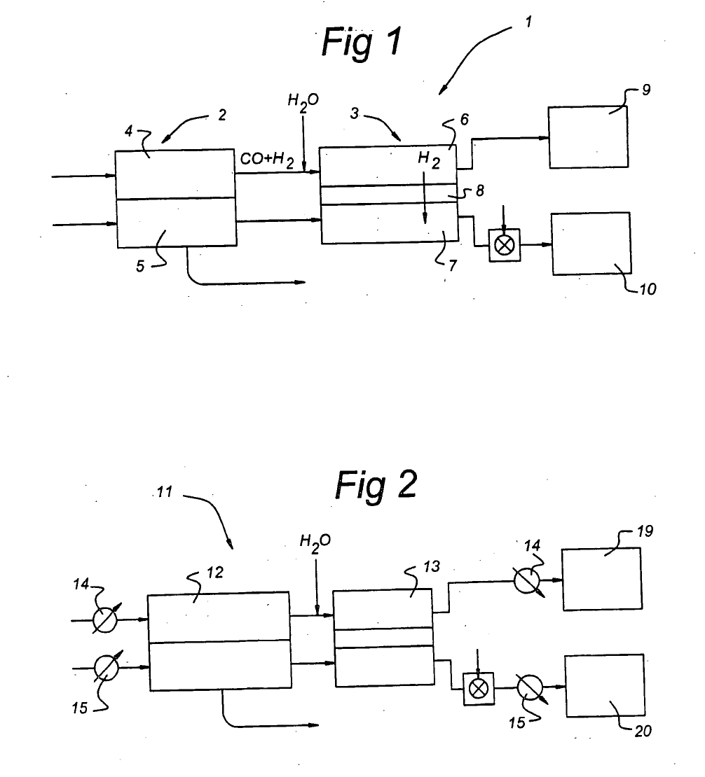

FIG. 2 shows a second embodiment;

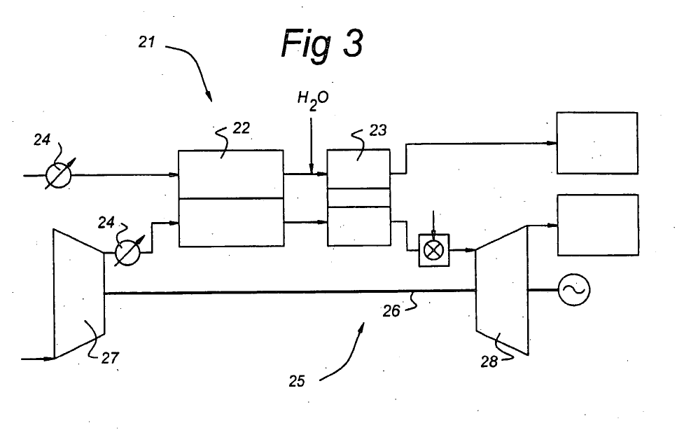

FIG. 3 shows a third embodiment;

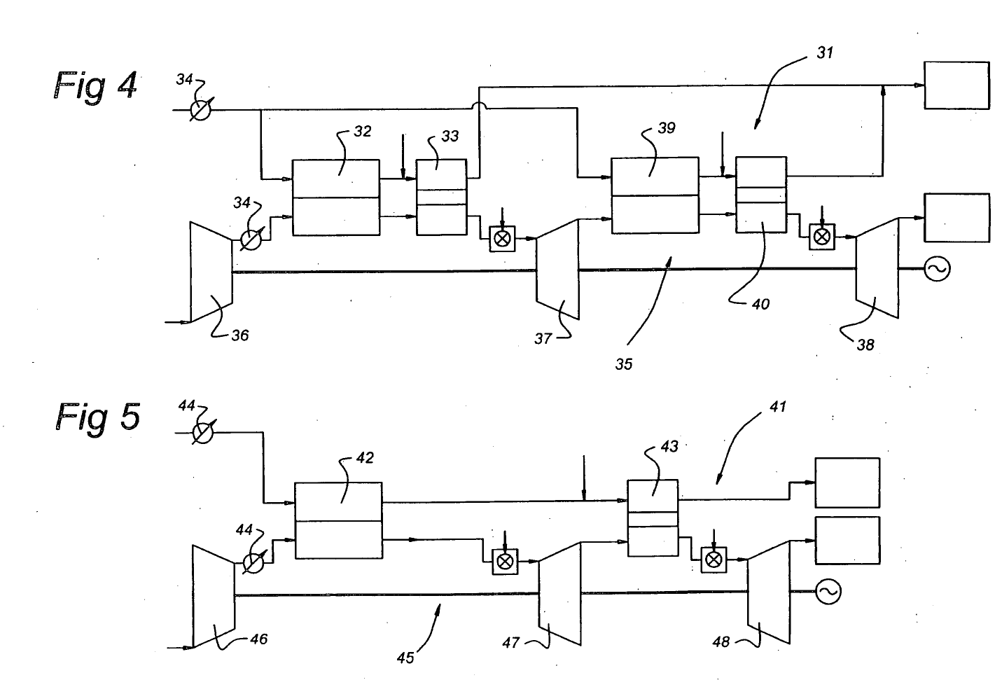

FIG. 4 shows a fourth embodiment;

FIG. 5 shows a fifth embodiment;

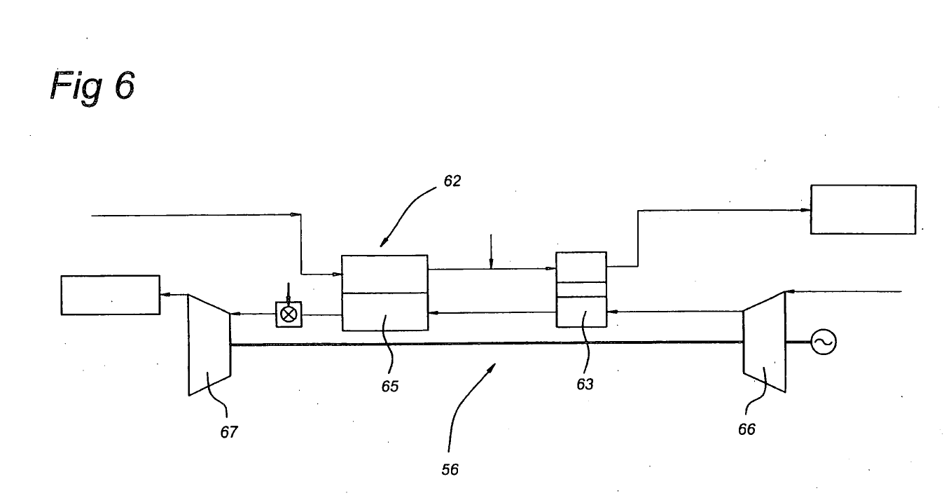

FIG. 6 shows a further variant of the invention, and

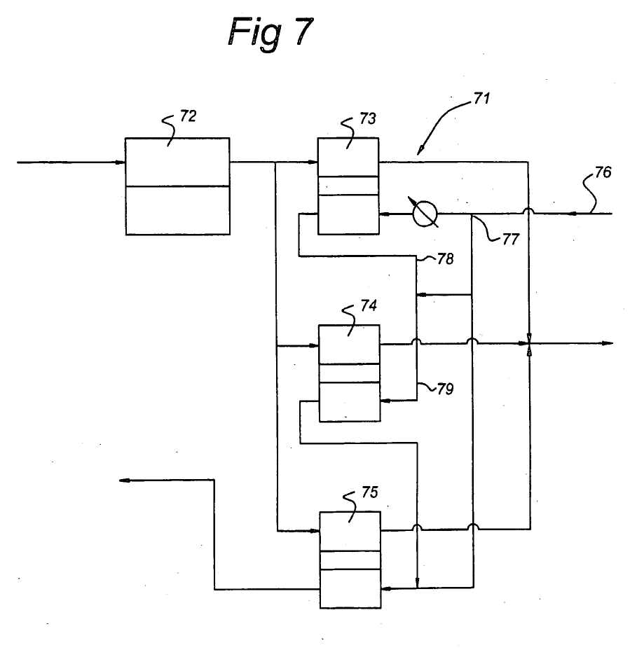

FIG. 7 shows a variant of FIG. 4.

An elementary embodiment of the system according to the present invention is shown by 1 in FIG. 1. This consists of an SOFC indicated by 2 and a shift membrane burner indicated by 3. The SOFC has an anode side 4 and a cathode side 5 separated by a membrane that is not indicated in more detail. A fuel, such as natural gas, is fed to the anode side; oxygen, for example in the form of air, is fed to the cathode side. The (carbon-containing) fuel is partially consumed on the anode side, whilst oxygen is present in excess. The fuel used can be mixed with water (vapour) or with recycled anode off-gas or off-gas from the shift membrane burner and optionally fed through a reformer before/at entering the fuel cell.

The anode off-gases are fed to the chamber 6 of the shift membrane burner. These off-gases consist mainly of carbon monoxide, hydrogen, carbon dioxide and water. Water (vapour) is optionally supplied before these off-gases enter chamber 6. Of course, water can also be fed separately into chamber 6. The water gas shift reaction takes place in chamber 6, carbon monoxide being reacted with water to give carbon dioxide and hydrogen. The membrane 8 of the shift membrane burner is so constructed that this is preferentially permeable to hydrogen. The hydrogen present in the shift membrane burner passes through this membrane because of the partial pressure difference or chemical potential difference between chamber 6, which is on the one side of the membrane, and chamber 7, which is on the other side of the membrane. Moreover, cathode off-gas that essentially consists of air with a reduced oxygen concentration originating from the fuel cell 2 is fed to this chamber 7. Combustion of hydrogen with oxygen takes place in chamber 7, water being formed. This combustion can be complete or partial.

The off-gases from chamber 6 consist essentially of CO₂ and water. After separating off water (block 9), which can take place in a simple manner by condensation or in any other manner known in the state of the art, CO₂ can be stored, optionally compressed. Any residues of carbon monoxide and hydrogen in the gas can be oxidised (catalytically) with oxygen (air).

The off-gases originating from chamber 7 can be used, after further heating if necessary, for recycling and/or residual heat utilisation, which is indicated by 10.

In this way it is possible with the aid of a fuel cell to generate electricity and to convert the anode off-gases to carbon dioxide and water, carbon dioxide being present in a very high concentration and therefore being able to be stored relatively easily or used for other purposes (storage in cylinders).

A variant of the system described above is shown in FIG. 2. The system according to FIG. 2 is indicated by 11 and consists of an SOFC 12, a shift membrane burner 13, a CO₂ store 19 and residual heat utilisation 20. The process takes place essentially in the same way as described above. However, the heat from the off-gases from the shift membrane burner is fed though heat exchanger 14 and 15, respectively, the heat-exchanging medium of which is the inflowing fuel and, respectively, the inflowing air. Of course, it is possible to reverse the flows, that is to say to combine the heat exchanger for the anode off-gases with the incoming air stream or to use the heat for other purposes.

A further system according to the invention is shown in FIG. 3 and the entirety is indicated by 21. This system consists of an SOFC 22 and a shift membrane burner 23. The anode off-gas is fed in the manner described above through the shift membrane burner and stored as relatively pure CO₂. Incoming fuel is optionally preheated via heat exchanger 24.

Cathode off-gas is brought into contact with hydrogen in the shift membrane burner and after further heating, if necessary, fed through the expander 28 of a gas turbine 25. The shaft 26 of expander 28 is coupled to a compressor 27 of turbine 25. By this means the pressure of the incoming air is increased, the temperature thereof rising. This air is optionally heated directly in heat exchanger 24. The energy for heat exchanger 24 is supplied by, for example, cathode off-gases, off-gases from a shift membrane burner, off-gases from an expander or additional burner.

The residual energy on shaft 26 is used to generate electricity, so that electrical energy is generated both by the SOFC and by the turbine.

A further system according to the present invention is shown in FIG. 4, so that the entirety is indicated by 31. In this system there are two SOFCs, indicated by 32 and 39. A shift membrane burner 33 is connected downstream of SOFC 32 and a shift membrane burner 40 downstream of SOFC 39. In both cases the outlet products at the combustion side of the shift membrane burner are fed to the expanders 37 and 38, respectively, of a gas turbine 35. By this means incoming air is compressed by compressor 36 and fed via a heat exchanger 34 to SOFC 32. The fuel is also fed through a heat exchanger 34 and fed to SOFC 32. Turbine 38 can also be used to generate energy.

In FIG. 5 a system 41 is shown where a single SOFC 42 is used and the cathode off-gas thereof is fed (after heating if necessary) to the expander 47 of a gas turbine 45 before being fed to the combustion part of a shift membrane burner. Following the combustion of hydrogen in the shift membrane burner, the gas produced during this combustion is fed (after heating if necessary) to a further expander 48 of the turbine 45. In the turbine 45, on the one hand, the incoming air is compressed and, on the other hand, electricity is generated. Heat exchangers are indicated by 44. The off-gases from the anode side of the SOFC are fed to the first chamber of the shift membrane burner.

If will be understood that the above gives only a diagrammatic indication of the many possibilities offered by the present invention. A wide variety of types of catalyst can be used in the shift membrane reactor. Furthermore, various types of membranes can be used, such as microporous membranes based on silica or zeolites. Membranes based on palladium and proton-conducting membranes are of particular interest because these are able to operate at higher temperatures.

A system indicated by 62 is shown in FIG. 6, with which, in contrast to the variants described above, air is first fed through the shift membrane burner indicated by 63. The air containing a lower percentage of oxygen is then fed to the fuel cell 65. There have been no changes on the fuel side of either the fuel cell or the shift membrane burner. The process of the transport of air can be promoted by the presence of a gas turbine 56, the compressor part of which is indicated by 66 and the expansion part of which is indicated by 67. This means that turbine 56 is optional.

A variant of the embodiment shown in FIG. 4 is indicated in its entirety by 71 in FIG. 7. A single SOFC 72 is shown in this example. There are three shift membrane burners 73, 74 and 75. It can be seen from FIG. 7 that the stream of off-gases originating from the anode is distributed over these three shift membrane reactors. The reaction described above with reference to the previous figures takes place in these reactors, that is to say hydrogen passes through the membrane. The incoming gas stream that contains oxygen is indicated by 76. This is split into three sub-streams at 77. The gas stream having the original composition at 76 is fed to the first shift membrane reactor 73. A portion of the water-enriched gas (stream 78) originating therefrom is mixed with a portion of the original oxygen-containing stream originating from 76 at 79 and this mixed stream is fed to the second shift membrane reactor 74. The same is repeated for the third shift membrane reactor 75. It has been found that, for example, when air is used as oxygen-containing stream sufficient oxygen is present to guarantee the conversion of hydrogen in the shift membrane reactor. A greater freedom in the selection of the fuel utilisation of the fuel cell 72 can be obtained in this way. A low utilisation of the fuel cell would mean that too great a difference between the inlet temperature and outlet temperature of a single shift membrane reactor would arise. The difference can be restricted with the aid of the circuit described above, as a result of which a broad field of utilisation of the fuel cell is obtained, that is to say a broad field as far as the composition of the anode off-gas stream that is fed to the shift membrane reactor is concerned. The heat-exchanging surface area required can also be reduced and a greater freedom is obtained in the design of the thermal management of the system. Furthermore, there is greater freedom of choice in respect of the design of the fuel cell and an improvement in the yield can be obtained for the process as a whole. Furthermore, as a result the temperature rises in that chamber of the second shift membrane reactor to which the anode off-gas is fed. This is also advantageous.

It will be understood that instead of three shift membrane reactors two or more than three shift membrane reactors could be used in the embodiment in FIG. 7. The compressor shown with reference to FIG. 4 can also be used. It will be understood that the use of two shift membrane reactors where the second shift membrane reactor is fed with the outlet product of the first shift membrane reactor can also be employed in the case of the embodiments according to the abovementioned figures other than FIG. 4.

Following the above it will be understood that numerous variants are possible by suitable combination of the various elements described above and further elements that are generally known to those skilled in the art. Such combinations fall within the scope of the appended claims.

1-19. (canceled)

20. Method for converting CO on one side of a membrane in the presence of water to CO₂ and H₂O on said one side of said membrane, H₂ passing through said membrane to the other side of said membrane and said hydrogen being combusted on said other side with oxygen fed to said other side, wherein the feed to the one side of the membrane comprises anode off-gas from a fuel cell.

21. Method according to claim 20, wherein said oxygen comprises cathode off-gas from a fuel cell.

22. Method according to claim 20, wherein said oxygen is fed to the cathode of a fuel cell.

23. Method according to claim 20, wherein said oxygen comprises air.

24. Method according to claim 20, wherein water is separated off from the off-gas originating from said one side of said membrane.

25. Method according to claim 20, wherein the heat from the off-gas from at least one of the sides of said membrane is recovered.

26. Method according to claim 20, wherein the oxygen-containing gas is introduced on said other side of the membrane under elevated pressure.

27. Method according to claim 20, wherein gas containing water originating from the other side of said membrane is fed to a further step for converting CO on one side of a further membrane in the presence of water to give CO₂ and H₂O on the one side of said further membrane, H₂ passing through said further membrane to the other side of said further membrane.

28. Method according to claim 27, wherein a separate oxygen-containing stream is fed to the inlet of said one side of said further membrane.

29. System comprising an SOFC fuel cell and a device for reacting CO and H₂, comprising a hydrogen-permeable membrane (8) bounded on either side by, respectively, a first and a second chamber, wherein said first chamber is provided with feed means for CO and H₂ and with discharge means for CO₂ and H₂O and said second chamber is constructed as a combustion chamber and is provided with oxygen feed means and water discharge means, wherein the anode outlet of said SOFC is connected to said first chamber.

30. System according to claim 29, wherein the cathode outlet of said SOFC is connected to said second chamber.

31. System according to claim 29, wherein the cathode inlet is connected to said second chamber.

32. System according to claim 29, wherein the outlet of said first chamber is provided with water removal means.

33. System according to claim 29, wherein the outlet of said second chamber is connected to the expander of a gas turbine.

34. System according to claim 33, wherein the gas fed to the second chamber of said membrane is fed through a compressor of said turbine.

35. System according to claim 29, wherein the outlet of said turbine is connected to the cathode inlet of a further SOFC.

36. System according to claim 35, wherein said further SOFC is connected to a system comprising an SOFC fuel cell and a device for reacting CO and H₂, comprising a hydrogen-permeable membrane (8) bounded on either side by, respectively, a first and a second chamber, wherein said first chamber is provided with feed means for CO and H₂ and with discharge means for CO₂ and H₂O and said second chamber is constructed as a combustion chamber and is provided with oxygen feed means and water discharge means, wherein the anode outlet of said SOFC is connected to said first chamber.

37. System according to claim 29, comprising a further device for reacting CO and H₂, comprising a hydrogen-permeable membrane delimited on either side by, respectively, a first and second chamber, wherein said first chamber is provided with feed means for CO and H₂ and is provided with discharge means for CO₂ and H₂O and said second chamber is constructed as a combustion chamber and provided with a feed connected to the discharge from the second chamber of said device for reacting CO and H₂.

38. System according to claim 37, wherein said second chamber is provided with separate oxygen feed means.
